(19) United States
(12) Patent Application Publication
(10) Pub. No.: US 2026/0037518 A1
(43) Pub. Date: Feb. 5, 2026

(54) TRANSLATION TABLE SHARING

(71) Applicant: SAP SE, Walldorf (DE)

(72) Inventors: Wolfgang Stephan, Heidelberg (DE); Manuel Mayr, Walldorf (DE); Jinyong Lee, Seoul (KR)

(21) Appl. No.: 18/794,320

(22) Filed: Aug. 5, 2024

(51) Int. Cl. G06F 16/2455; G06F 16/22; G06F 16/2453

(52) U.S. Cl. CPC G06F 16/2456; G06F 16/2255; G06F 16/24544

(57) ABSTRACT

In some embodiments, there is provided performing a table scan semi-join on a plurality of second value second identifier of the second table by scanning a plurality of second value identifiers that have been filtered by the translated plurality of first value identifiers and reading one or more filtered second value identifiers of the second table, providing the one or more filtered second value identifiers of the second table as a probe into the hash table including the translated plurality of first value identifiers, and outputting one or more matching rows corresponding to matching value identifiers for matching values in the first table and the second table. Related systems, methods, and articles of manufacture are also disclosed.

### TECHNICAL FIELD

The subject matter described herein relates generally to optimizing database query execution.

### BACKGROUND

A database may be configured to store a plurality of electronic data records. These data records may be organized, in accordance with a database schema, into various database objects including, for example, one or more database tables. The database is coupled with a database management system (DBMS), which may be configured to support a variety of database operations for accessing the data records stored in the database. These database operations may include, for example, structured query language (SQL) queries and/or the like.

### SUMMARY

Systems, methods, and articles of manufacture, including computer program products, are provided for translation table sharing. In some embodiments, there is provided a method that includes detecting, in a query execution, a join of a first table and a second table; and in response to the detecting the join, optimizing the query execution by at least scanning a plurality of first value identifiers from the first table, translating the plurality of first value identifiers into a value identifiers domain of the second table to form a shared translation table, building a hash table using the translated plurality of first value identifiers, performing a table scan semi-join on a plurality of second value second identifier of the second table by scanning a plurality of second value identifiers that have been filtered by the translated plurality of first value identifiers and reading one or more filtered second value identifiers of the second table, providing the one or more filtered second value identifiers of the second table as a probe into the hash table including the translated plurality of first value identifiers, and outputting one or more matching rows corresponding to matching value identifiers for matching values in the first table and the second table.

In some implementations, the current subject matter includes one or more of the following optional features. A database execution engine may detect the join of the first table and the second table. The join may include an inner join of a first column of the first table and a second column of the second table. The first column may include the plurality of first value identifiers, and wherein the second column includes the plurality of second value identifiers. The translating may include generating the shared translation table based a first dictionary of the plurality of first value identifiers and a second dictionary of the plurality of second value identifiers. The building of the hash table may include inserting the translated plurality of first value identifiers into the hash table. The plurality of second value identifiers may be filtered by a filter, wherein the filter detects whether or not the translated plurality of first value identifiers in the plurality of second value identifiers. The filter may include a bloom filter.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a logical representation of a portion of a query plan that includes a hash join operator, in accordance with some example embodiments;

FIG. 1B depicts an example of a portion of a query plan that includes a hash join that uses a table scan semi-join, in accordance with some example embodiments;

FIG. 1C depicts an example of a portion of a query plan that includes a hash join using valueIDs as a hash join condition, in accordance with some example embodiments;

FIG. 2 depicts an example of a portion of a query plan that includes a hash join using translation table sharing, in accordance with some embodiments;

FIG. 3 depicts an example of a computing system, in accordance with some example embodiments;

FIG. 4 depicts an example of a process for sharing a translation table during a hash join, in accordance with some example embodiments; and

FIGS. 5A and 5B depict additional block diagrams for a system, in accordance with some example embodiments.

When practical, similar reference numbers denote similar structures, features, or elements.

### DETAILED DESCRIPTION

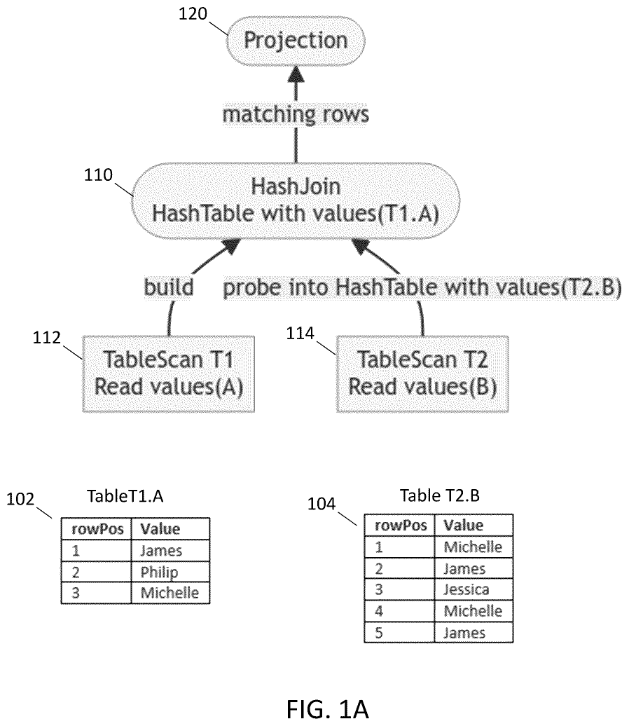

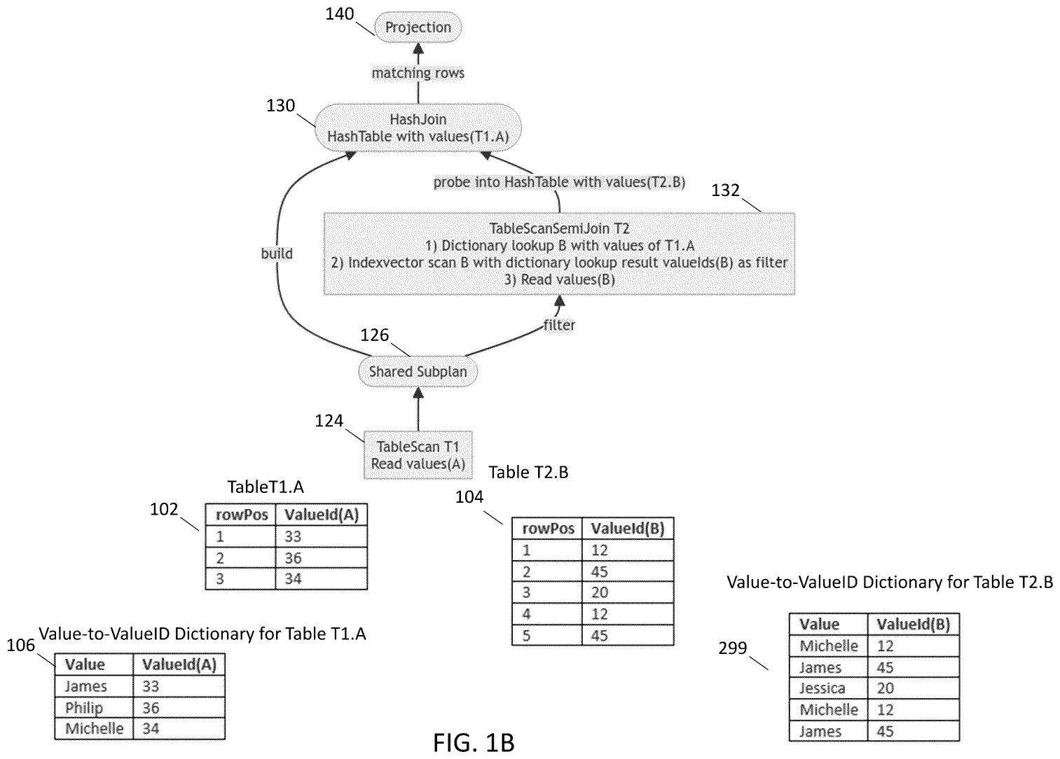

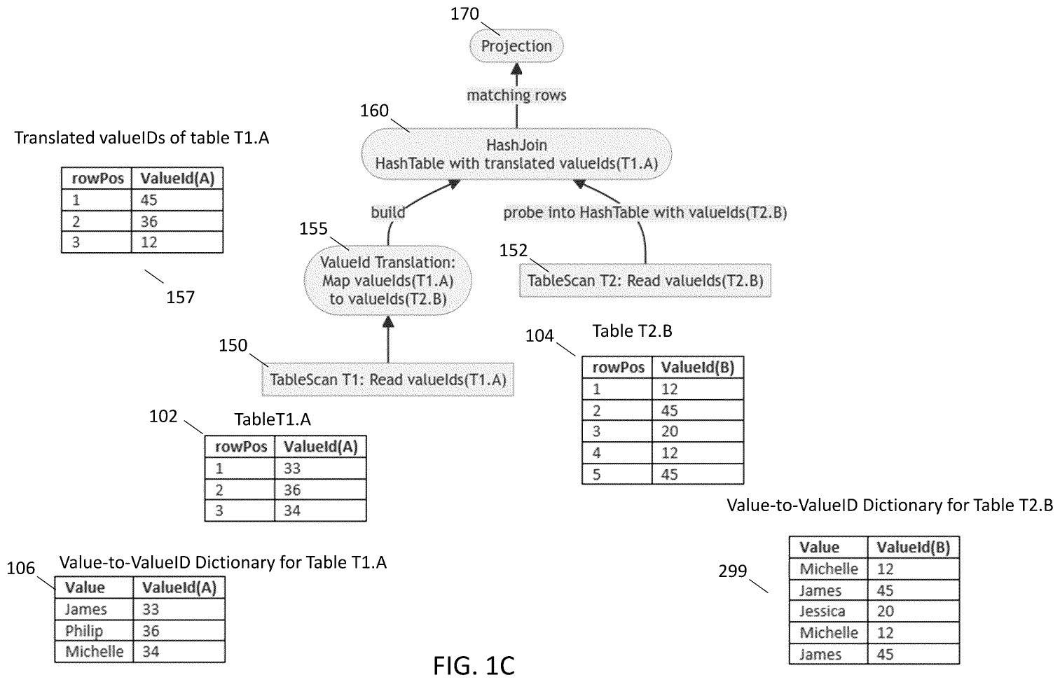

Databases including in-memory databases as well as other types of databases may store data in a table. FIG. 1A depicts a logical representation of a portion of a query plan including a hash join operator (or hash join for short) that involves two tables, table T1.A 102 and table T1.B 104. In the example of FIG. 1A, the query plan includes a hash join operator 110. The hash join is a way to join “matching values” in two tables, such as table T1.A 102 and table T1.B 104. In the build side of the hash join, a table scan 112 of table T1.A is performed to build a hash table of the values of table T1.A. On the probe side of the hash join, the table scan 114 scans the values from table T2.B and provides the matching table values (or, e.g., row identifiers for those values) as an output at the projection 120. This hash-join may be costly with respect to resource use (e.g., processor, memory, and time). But a semi-join may be used to improve the join depicted at FIG. 1A. Although FIG. 1A describes tables T1.A and tables T2.B, these tables may refer to table columns of the same table or different tables (or rows of the same table or different tables as well).

FIG. 1B depicts an example of a portion of a query plan include a hash join that uses a table scan semi-join. In the example of FIG. 1B, a table scan semi join 132. For example, a table scan 124 of the values of table T1.A 102 is performed. The read values are used to build the hash table for the hash join 130. The read values of table T1.A 102 are also used to look up in a dictionary 299 the index values (“valueIDs”). For example, the read or scanned value “James” of Table T1.A is used in dictionary 299 to identify valueID 45 for Table T2.B. The valueIDs obtained from the dictionary 299 are then used as a filter of the valueIDs of table T2.B 104 to obtain or read only the matching valueIDs in table T2.B. In the example of FIG. 1B, the valueIDs “45” and “12” from the dictionary 299 are used to filter table T2.B, so only the values for 45 (“James”) and 12 (“Michelle”) are read (at table scan semi join 132). These matching values (or the corresponding row identifiers for the matching values) may be output as a projection operation 140. The table scan semi join 132 can thus reduce the number of rows being probed at table T2.B during the hash table probing. The shared subplan 126 dispatches the result of the Table Scan T1 124 to both the hash join 130 build side and the table scan semi join 132.

FIG. 1C depicts an example of a portion of a query plan include a hash join that uses valueIDs as a hash join condition, rather than values as in the case of FIG. 1B, for example. Referring to FIG. 1C, the table scan operator 150 reads the valueIDs, such as 33, 36, and 34 from table T1.A 102. Likewise, the table scan operator 152 reads the valueIDs, such as 12, 45, 20, and so forth from table T1.B 104. As table TIA 102 has a dictionary 106 to map valueIDs to values and table T2.B 104 has a dictionary 299 to map valueIDs to values, a valueID translation operation 155 is used to map or translate the valueIDs from the dictionary 106 to the dictionary 299 (or from dictionary 299 to dictionary 106). In the example of FIG. 1C, the valueID “33” in the dictionary 299 corresponds to “James”, but dictionary 299 uses valueID “45” for “James”. The valueID translation operation 155 translates the valueID “33” into the valueID 45 as shown at a translated table 157 (which represents table T1.A 102 after the valueID translation provided by valueID translation operation 155). As such, the hash table of the hash join 160 may be filled with the “translated” valueIDs of the shared translation table 157, and the probe into the hash table uses the valueIDs of table T2.B to provide the matching rows (or, e.g., the corresponding row identifiers of the matching row values) that are output by the projection operation 170.

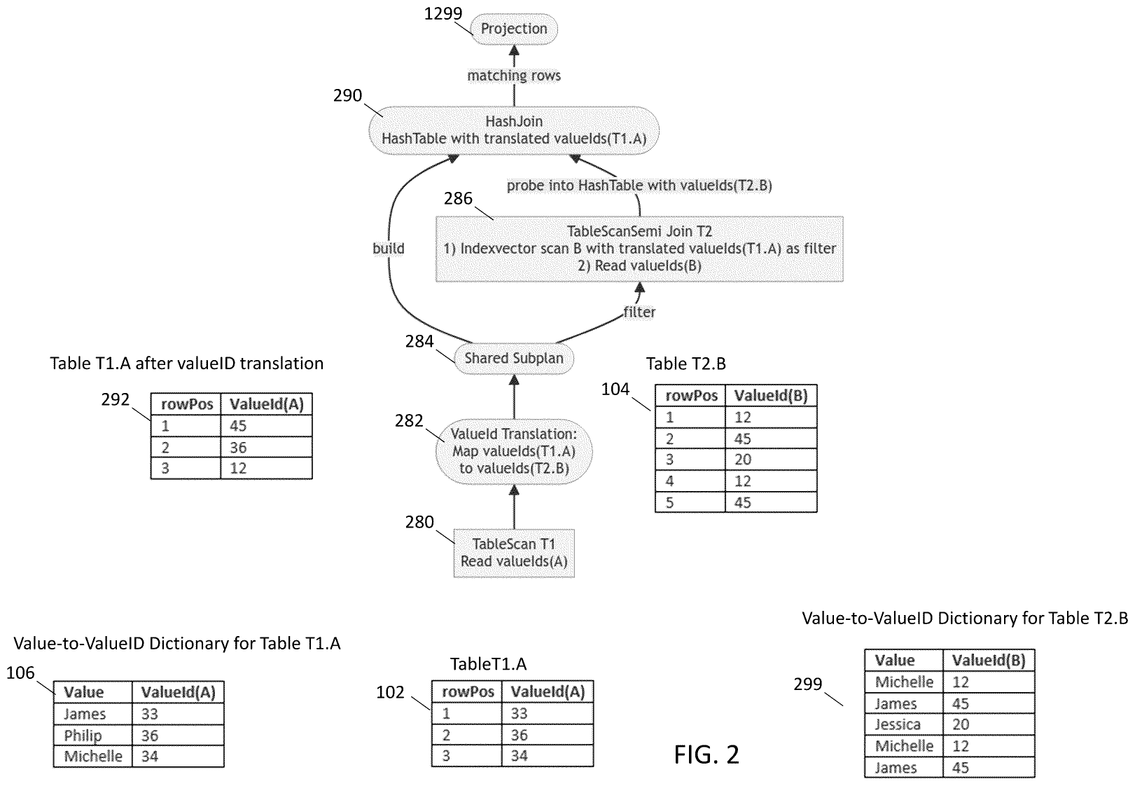

FIG. 2 depicts an example of a portion of a query plan that include a hash join using table sharing, in accordance with some embodiments.

In the example of FIG. 2, the valueIDs are used as a hash join condition, rather than values as in the case of FIG. 1B. The table scan operator 280 scans table T1.A 102 and reads the valueIDs of table T1.A 102, such as valueIDs 33, 36, 34, and so forth. The valueID translation operator 282 maps the valueIDs of table T1.A into the valuesIDs of table T1.B (or vice versa), so table T1.A's values to valueIDs mappings are the same as table T2.B's values to valueIDs mappings. In other words, after the translation 182, the table T1.A and table T2.B share a common dictionary (also referred to as a shared translation table) to map valueIDs to values, so the valueID “45” (see, e.g., table 292) maps to the value “James” in both tables T1.A 292 and table T1.B 104. Using the shared subplan 284, the hash join 290 (also referred to as a hash join operator) is used to build a hash join table using the translated valueIDs 299 of table T1.A. In other words, the hash table includes a list of valueIDs from translated table T1.A 292. On the probe side of the hash join, a table scan semi join uses the translated valueIDs 292 as a filter to perform an index scan of value IDs table T1.B 104. The filtered valueIDs from table T1.B 104 represent the matching valueIDs that are output (at least the rows position of the matches) by a projection operator 299.

Before providing additional details with respect to improved hash joins, an example of a system environment is described.

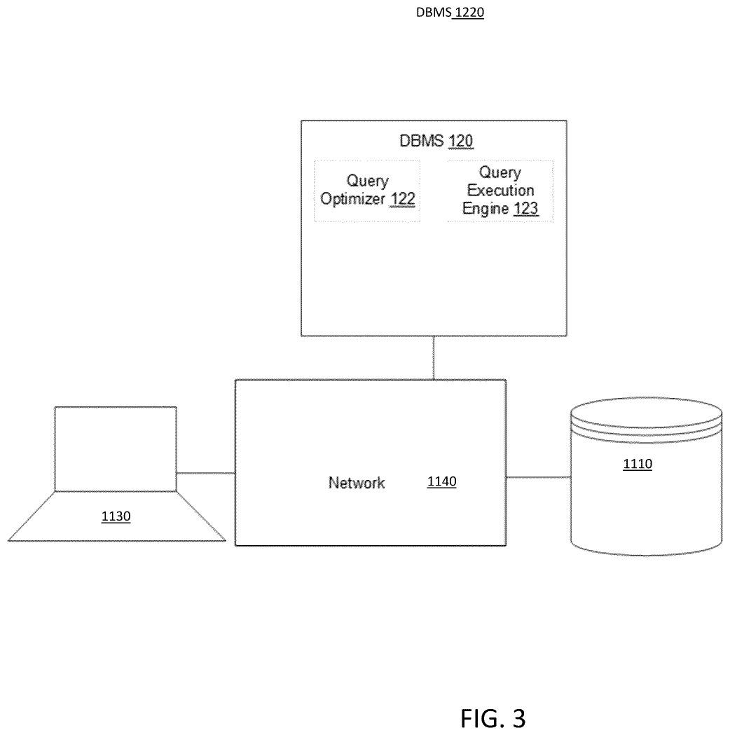

FIG. 3 depicts an example of a computing system 300, in accordance with some example embodiments. Referring to FIG. 3, the computing system 300 may include a database 1110, a database management system (DBMS) 1220, and a client device 1130. For example, the database management system 1220 may include a query optimizer 122, a query execution engine 123, and other components or functions. It is noted that while only a single database 1110 and a single client device 1130 are shown, this is merely to avoid cluttering the figure. It should be appreciated that database 1a10 is representative of any number of databases 1110 and client device 1130 is representative of any number of client devices that may included as part of computing system 100.

From an application or client perspective, it can be extremely cumbersome to access databases such as database 1110. For example, an application may need to query different types of databases using complex queries. As a consequence, the application layer in this example would need to be configured to handle the various types of databases and the various query types. Additionally, or alternatively, each database 1110 may need to process queries from the application into a format and structure that can be handled by the given database. Pushing complex operations and support for a variety of different database types to the application layer may contravene the need to have relatively lighter weight and/or readily deployable applications. On the other hand, pushing complex operations to the database layer where data is stored may draw processing and/or memory resources at the database 1110 and may thus reduce the performance and response times for queries on that database layer.

In some example implementations, there may be provided a query execution engine 123 (also referred to as a database execution engine) that may decouple the higher-level, application layer from the database layer (e.g., the persistence or storage layer where data including database tables may be stored and/or queried using instructions, such as commands and/or the like). The query execution engine 123 may be implemented separately from the database layer (e.g., at database 1110) and/or the application layer, although the query execution may be implemented as part of the application or database later as well. Further, the query execution engine 123 may be configured to receive a query, generate a query plan (including for example query algebra), optimize the query plan, and/or generate executable code, which can be executed at runtime. The executable code may include pre-compiled code (which can be selected for certain operations in the query plan) and/or code that is generated just-in-time specifically for execution of the query plan.

The database 1110, the database management system 1220, and the client device 1130 may be communicatively coupled via a network 1140. In some example embodiments, the database 1110 may be a relational database. However, it should be appreciated that the database 1110 may be any type of database including, for example, an in-memory database, a hierarchical database, an object database, an object-relational database, and/or the like. For example, instead of and/or in addition to being a relational database, the database 1110 may be a graph database, a column store, a key-value store, a document store, and/or the like.

The database management system 1220 may be configured to respond to requests from one or more client devices including, for example, the client device 130. For example, as shown in FIG. 1, the client device 1130 may communicate with the database management system 1220 via the network 1140, which may be any wired and/or wireless network including, for example, a public land mobile network (PLMN), a wide area network (WAN), a local area network (LAN), a virtual local area network (VLAN), the Internet, and/or the like. The client device 1130 may be a processor-based device including, for example, a smartphone, a tablet computer, a wearable apparatus, a virtual assistant, an Internet-of-Things (IoT) appliance, and/or the like.

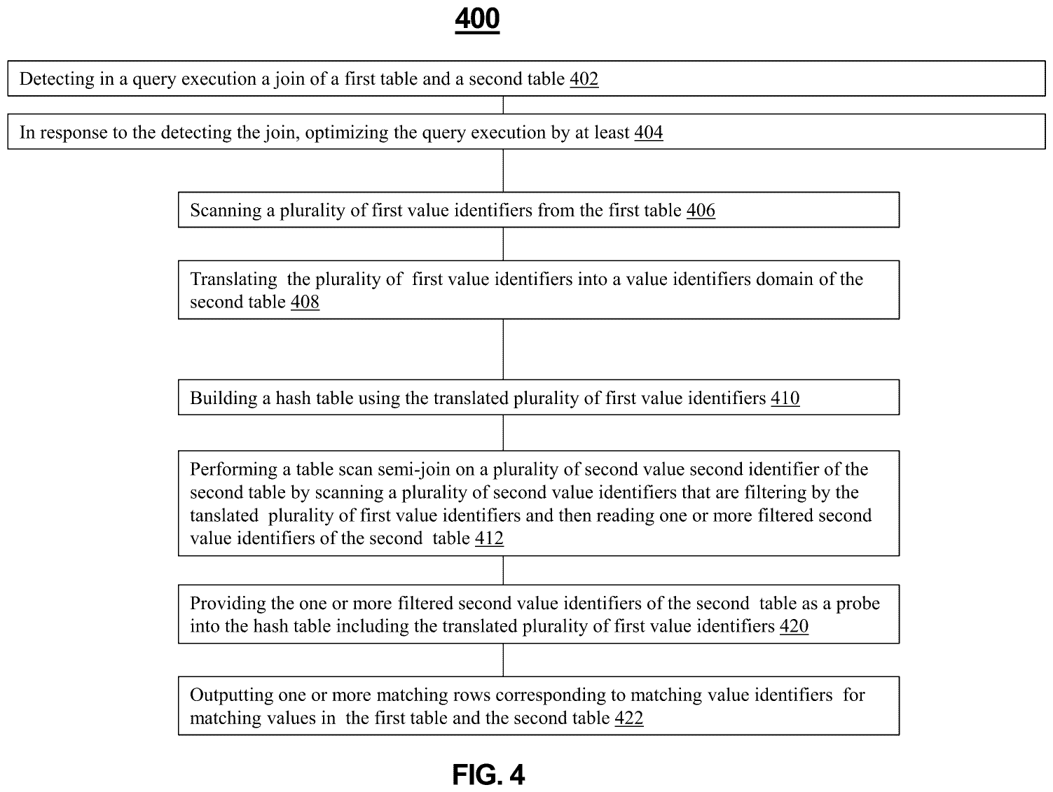

FIG. 4 process 400 for sharing a translation table during a hash join, in accordance with some embodiments. The description of FIG. 4 also refers to FIG. 2.

The process 400 may include detecting, at 402, in a query execution, a join of a first table and a second table. Referring to the example of FIG. 2, the query execution may include a join of two tables, such as table T1.A 102 and table T2.B 104. As used herein, a “join” refers to an operation used to combine data from multiple tables, columns, or rows based on a common condition between them. For example, the join may combine matching values in two columns and output the matches (in which case, the join may be referred to as an inner join). When this is the case, the process 400 may include in response to the detecting the join, optimizing the query execution at 404.

The optimizing may include scanning, ay 406, a plurality of first value identifiers from the first table. Referring to the example of FIG. 2, a plurality of value identifiers, such 33, 36, and 34, may be scanned (e.g., read) from table T1.A 102. Next, the plurality of first value identifiers may be translated at 408 into a value identifiers domain of the second table. For example, the valueIDs of table T1.A 102 may be mapped into the same value identifier domain as the value identifiers of table T2.B, so the table T1.A and table T2.B share a common dictionary of value identifiers that map valueIDs to values. In other words, the common dictionary may provide a shared translation table that can be used to translate both the plurality of first value identifiers into values and the plurality of second value identifiers into values. For example, the values James (with valueID 33), Phillip (with valueID 36), and Michelle (with valueID 34) may be translated using the second dictionary 299 in to values James (with valueID 45), Phillip (with valueID 36 as the second dictionary lacks Phillip it remains as a 36), and Michelle (with valueID 12) as shown at the shared translation table 157. As used herein, the “value identifier” refers to a vector or a string used to encode, using a dictionary, an actual value, such that the database table stores the value identifier in a database table.

At 410, a hash table may be built using the translated plurality of first value identifiers. For example, the hash table of the hash join 290 may be filled to include the translated plurality of first value identifiers, such as the valueIDs 292.

At 412, a table scan semi-join may be performed on a plurality of second value second identifier of the second table by scanning the plurality of second value identifiers which have been filtered by the translated plurality of first value identifiers and reading one or more filtered second value identifiers of the second table. For example, the table scan semi join 286 may scan he table T2.B 104 for the plurality of second value identifiers that have been filtered using the first plurality of valueIDs of the first table 292. For example, a filter may be used to detect whether the translated plurality of first value identifiers are in the plurality of second value identifiers are filtered. For example, a bloom filter may be used to detect whether or not a given valueID of the plurality of second value identifiers are a member of the set of translated plurality of first value identifiers.

At 420, the one or more filtered second value identifiers of the second table may be provided as a probe into the hash table including the translated plurality of first value identifiers. For example, the second value identifiers filtered at 412 may then be provided as a probe into the hash table (which was filled at 410 with the translated plurality of first value identifiers).

At 422, one or more one or more matching rows corresponding to matching value identifiers for matching values in the first table and the second table may be output. For example, matching rowIDs in each dictionary 106 and dictionary 299 may be output by the projection 1299 to indicate the matching values in the first and second tables.

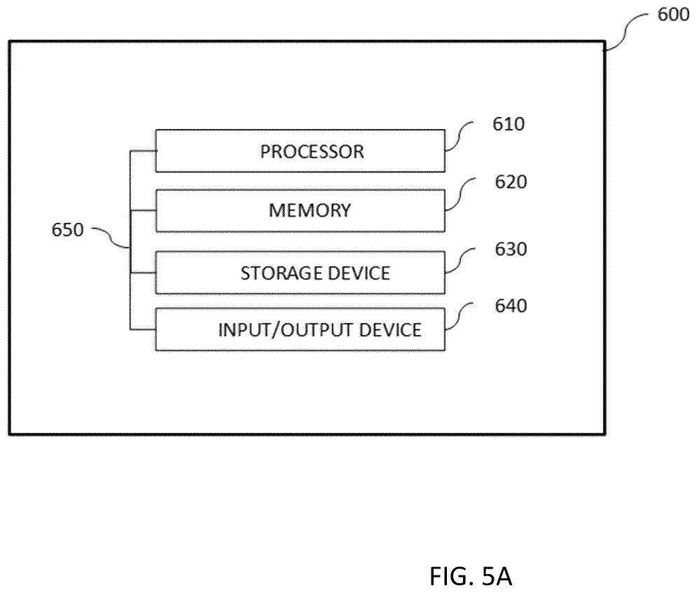

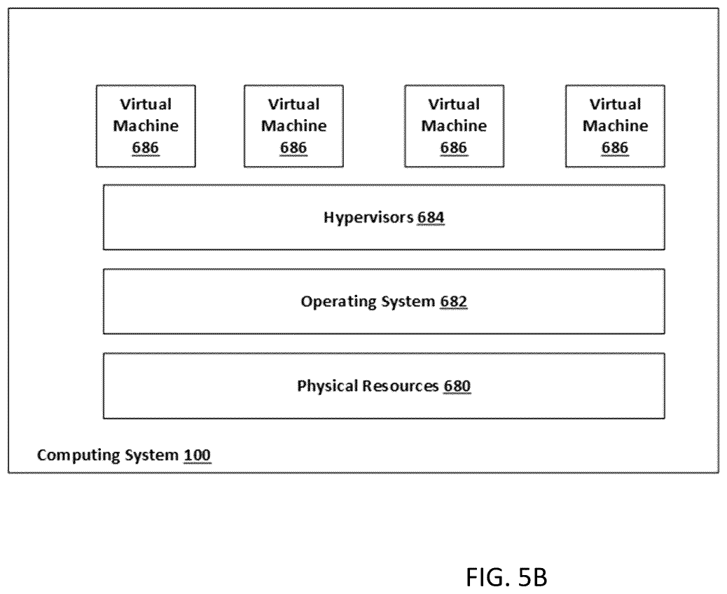

In some implementations, the current subject matter may be configured to be implemented in a system 600, as shown in FIG. 5A. The system may be used to provide one or more aspects disclosed herein, such as an execution engine or query optimizer or other component used to cause one or more of the operations of FIG. 4, for example. The system 600 may include a processor 610, a memory 620, a storage device 630, and an input/output device 640. Each of the components 610, 620, 630 and 640 may be interconnected using a system bus 650. The processor 610 may be configured to process instructions for execution within the system 600. In some implementations, the processor 610 may be a single-threaded processor. In alternate implementations, the processor 610 may be a multi-threaded processor. The processor 610 may be further configured to process instructions stored in the memory 620 or on the storage device 630, including receiving or sending information through the input/output device 640. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

FIG. 5B depicts an example implementation of the system 600 (of FIG. 3). The system 600 may be implemented using various physical resources 880, such as at least one or more hardware servers, at least one storage, at least one memory, at least one network interface, and the like. The system 600 may also be implemented using infrastructure, as noted above, which may include at least one operating system 882 for the physical resources 880 and at least one hypervisor 884 (which may create and run at least one virtual machine 886).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

Example 2: The computer-implemented method of Example 1, wherein a database execution engine detects the join of the first table and the second table.

Example 3: The computer-implemented method of any of Examples 1-2, wherein the join comprises an inner join of a first column of the first table and a second column of the second table.

Example 4: The computer-implemented method of any of Examples 1-3, wherein the first column includes the plurality of first value identifiers, and wherein the second column includes the plurality of second value identifiers.

Example 5: The computer-implemented method of any of Examples 1-4, wherein the translating comprises generating the shared translation table based a first dictionary of the plurality of first value identifiers and a second dictionary of the plurality of second value identifiers.

Example 6: The computer-implemented method of any of Examples 1-5, wherein the building of the hash table comprises inserting the translated plurality of first value identifiers into the hash table.

Example 7: The computer-implemented method of any of Examples 1-6, wherein the plurality of second value identifiers are filtered by a filter, wherein the filter detects whether or not the translated plurality of first value identifiers in the plurality of second value identifiers.

Example 8: The computer-implemented method of any of Examples 1-7, wherein the filter comprises a bloom filter.

Example 9: A system comprising:
at least one processor;
at least one memory including program code which when executed by the at least one processor causes operations comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

Example 10: The system of Example 9, wherein a database execution engine detects the join of the first table and the second table.

Example 11: The system of any of Examples 9-10, wherein the join comprises an inner join of a first column of the first table and a second column of the second table.

Example 12: The system of any of Examples 9-11, wherein the first column includes the plurality of first value identifiers, and wherein the second column includes the plurality of second value identifiers.

Example 13: The system of any of Examples 9-12, wherein the translating comprises generating the shared translation table based a first dictionary of the plurality of first value identifiers and a second dictionary of the plurality of second value identifiers.

Example 14: The system of any of Examples 9-13, wherein the building of the hash table comprises inserting the translated plurality of first value identifiers into the hash table.

Example 15: The system of any of Examples 9-14, wherein the plurality of second value identifiers are filtered by a filter, wherein the filter detects whether or not the translated plurality of first value identifiers in the plurality of second value identifiers.

Example 16: The system of any of Examples 9-15, wherein the filter comprises a bloom filter.

Example 17: A non-transitory computer-readable storage medium including program code which when executed by at least one processor causes operations comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

Example 18: The non-transitory computer-readable storage medium of Example 18, wherein a database execution engine detects the join of the first table and the second table.

Example 19: The non-transitory computer-readable storage medium of any of Examples 17-18, wherein the join comprises an inner join of a first column of the first table and a second column of the second table.

Example 20: The non-transitory computer-readable storage medium of any of Examples 17-19, wherein the first column includes the plurality of first value identifiers, and wherein the second column includes the plurality of second value identifiers.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

The illustrated methods are exemplary only. Although the methods are illustrated as having a specific operational flow, two or more operations may be combined into a single operation, a single operation may be performed in two or more separate operations, one or more of the illustrated operations may not be present in various implementations, and/or additional operations which are not illustrated may be part of the methods.

What is claimed is:

1. A computer-implemented method comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

2. The computer-implemented method of claim 1, wherein a database execution engine detects the join of the first table and the second table.

3. The computer-implemented method of claim 1, wherein the join comprises an inner join of a first column of the first table and a second column of the second table.

4. The computer-implemented method of claim 3, wherein the first column includes the plurality of first value identifiers, and wherein the second column includes the plurality of second value identifiers.

5. The computer-implemented method of claim 1, wherein the translating comprises generating the shared translation table based a first dictionary of the plurality of first value identifiers and a second dictionary of the plurality of second value identifiers.

6. The computer-implemented method of claim 1, wherein the building of the hash table comprises inserting the translated plurality of first value identifiers into the hash table.

7. The computer-implemented method of claim 1, wherein the plurality of second value identifiers are filtered by a filter, wherein the filter detects whether or not the translated plurality of first value identifiers in the plurality of second value identifiers.

8. The computer-implemented method of claim 7, wherein the filter comprises a bloom filter.

9. A system comprising:
at least one processor;
at least one memory including program code which when executed by the at least one processor causes operations comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

10. The system of claim 9, wherein a database execution engine detects the join of the first table and the second table.

11. The system of claim 9, wherein the join comprises an inner join of a first column of the first table and a second column of the second table.

12. The system of claim 11, wherein the first column includes the plurality of first value identifiers, and wherein the second column includes the plurality of second value identifiers.

13. The system of claim 9, wherein the translating comprises generating the shared translation table based a first dictionary of the plurality of first value identifiers and a second dictionary of the plurality of second value identifiers.

14. The system of claim 9, wherein the building of the hash table comprises inserting the translated plurality of first value identifiers into the hash table.

15. The system of claim 9, wherein the plurality of second value identifiers are filtered by a filter, wherein the filter detects whether or not the translated plurality of first value identifiers in the plurality of second value identifiers.

16. The system of claim 15, wherein the filter comprises a bloom filter.

17. A non-transitory computer-readable storage medium including program code which when executed by at least one processor causes operations comprising:
detecting, in a query execution, a join of a first table and a second table; and
in response to the detecting the join, optimizing the query execution by at least scanning a plurality of first value identifiers from the first table,
translating the plurality of first value identifiers into a value identifiers domain of the second table to form a shared translation table,
building a hash table using the translated plurality of first value identifiers,
performing a table scan semi-join on a plurality of second value second identifier of the second table by scanning a plurality of second value identifiers that have been filtered by the translated plurality of first value identifiers and reading one or more filtered second value identifiers of the second table,
providing the one or more filtered second value identifiers of the second table as a probe into the hash table including the translated plurality of first value identifiers, and
outputting one or more matching rows corresponding to matching value identifiers for matching values in the first table and the second table.

18. The non-transitory computer-readable storage medium of claim 17, wherein a database execution engine detects the join of the first table and the second table.

19. The non-transitory computer-readable storage medium of claim 17, wherein the join comprises an inner join of a first column of the first table and a second column of the second table.

20. The non-transitory computer-readable storage medium of claim 19, wherein the first column includes the plurality of first value identifiers, and wherein the second column includes the plurality of second value identifiers.
